(19) United States
(12) Patent Application Publication
(10) Pub. No.: US 2005/0168890 A1
(43) Pub. Date: Aug. 4, 2005

(54) Method & apparatus for transient suppressing high-bandwidth voltage regulation

(76) Inventor: Rajendran Nair, Gilbert, AZ (US)

Correspondence Address: Rajendran Nair, ComLSI Inc., 3838 E. Encinas Ave., Gilbert, AZ, 85234, US

(21) Appl. No.: 10/766,270

(22) Filed: Jan. 29, 2004

(51) Int. Cl. H02H 7/00

(52) U.S. Cl. 361/18

(57) ABSTRACT

A high-bandwidth, transient suppressing voltage down-converter apparatus and a method for transient suppression in such converters is disclosed. The invention is an integrated voltage converter electronic circuit, comprising of a first switch device connecting to an input power node at one of it's channel terminals and to a first integrated inductor at the other, with the first inductor's second terminal connecting to an output node, where this series combination of the first switch and the first inductor is a portion of an integrated voltage down-converter, a bypass circuit path, formed by a second switch device, or a series combination of a second switch device equivalent to the first switch device and a second inductor of the same self-inductance value as the first inductor, where the bypass circuit path connects between the input power node and the output power node of the integrated circuit in an electrically parallel configuration with the series combination of the first switch and the first inductor, voltage conversion circuits and conversion-bypass control circuits, receiving a plurality of signals as input, and connecting to the power input and output nodes of the integrated circuit as well as the control inputs of the first and second switch devices, and a common semiconductor substrate upon which the first switch device, the second switch device, necessary voltage conversion and control circuits, the first inductor, and the second inductor are fabricated.

### TECHNICAL FIELD OF THE INVENTION

Embodiments of the invention relate to electronic circuitry commonly employed to provide regulated voltages to high frequency, high-power VLSI devices. Such circuitry falls under the broad category of power management electronics.

### BACKGROUND & PRIOR ART

The continuing scaling of transistor dimensions, the associated increase in the number of integrated transistors and the continuing demand for ever greater performance places an increasing burden upon the electronic circuitry that delivers the power demanded by components such as microprocessors. As seen in the ‘power delivery’ section of reference [3], the scaling requirements imposed upon interconnect components that marry high-power/performance IC's to support electronic devices are integer exponents of the typical semiconductor fabrication process scaling factor. It has been shown, considering typical microprocessors in desktop computers, that the scaling for the loop inductance between the capacitance that is electrically and physically closest to the microprocessor die and the circuits on the die will need to be at least the 3^{rd} exponent of the process scaling factor in a scaling arrangement where the power consumed in the scaled component remains the same as the power consumed by the prior generation component. The resistances of the intervening interconnect between the power conversion components (typically referred to as Voltage Regulation Modules or VRM's) and the processor die will need to scale inversely as the square of the increase in the supply current flowing in order to maintain the power wasted in the interconnect approximately the same. It may be foreseen by a person skilled in the art of electronic design that scaling the interconnect architecture along the requirements indicated will require new, innovative changes to the interconnect architecture.

Another problem specific to microprocessors most commonly used in desktop computers of the present is the immediate requirement for a high percentage of the peak operating current during the transition of the processor from an inactive operational state to a fully active one. When imposed upon the prior art power delivery network of passive components (banks of capacitors and the intervening interconnect, represented by their inductance), such sudden demand in current produces power supply ‘droops’ or sudden reductions in the available electromotive force within the processor (reference [3], Power Delivery section). Because of the slow speed of response of the VRM's and the intervening power distribution network's delays, these droops can last for substantial durations and often result in a failure of operation of the processor. No prior art solution that satisfactorily addresses this problem exists; the problem has been contained this far through the continuing scaling of the power delivery capacitors and inductances.

The need to minimize power consumption for high-performance components such as processors has perhaps never been felt as greatly as in the present time. Prior research has shown that reducing the operating voltage can bring about a cubic reduction in power consumption. Such power delivery architectures have been implemented in very low power processors employed in ‘Thin Clients’ and ‘Notebook’ computers in the art. A person skilled in the art may appreciate that the prior art power delivery system associated with microprocessors in common desktop computers is not suited to operating voltage shifts at the speeds at which a gigahertz processor may require them to be. A need therefore exists for an innovative power delivery system for high-power, high frequency components that addresses these problems described.

The invention specifies an innovative integration of devices and function that successfully addresses these problems in the state of the art.

### SUMMARY OF THE INVENTION

The invention is a high-bandwidth voltage conversion system with integrated provisions for bypassing the voltage conversion circuits incorporated therein. High-frequency-capable power transistors and small-value inductors, fabricated as an interconnect layer immediately above the layer containing the transistor devices, facilitate a high frequency, high efficiency DC-to-DC conversion system. In addition, a path demonstrating very low impedance to charge flow with the required frequency performance is integrated within the same component. This path is activated during load events that demand a sudden, high charge flow requirement, bypassing the DC-to-DC conversion path that has a limited bandwidth. During such ‘transient’ events, therefore, the input filter to the DC-to-DC conversion system is effectively shorted to the output filter, sharing the charge in the high-voltage capacitors of the input filter with the low-voltage capacitors of the output filter, substantially augmenting the charge that the low-voltage capacitors provide to the load. The rate of flow of ‘bypass’ charge is limited primarily by the input filter characteristics.

The integration of the power transistors for the DC-to-DC conversion system with the necessary inductors and the bypass solution on the same integrated circuit substrate is key to the implementation of the solution. Additionally, it is also essential that the invention be placed at close proximity to the load device in order to maximize the benefit of the bypass function. For example, a placement on the very same package substrate that the load device is mounted upon, but on the opposite side of the substrate, such that the physical distance between the circuits on the load device and the invention is greatly minimized, will be a recommended best mode for the use of the invention. This proximity of the invention to the load device also enables speedy local communication between the load device and one or more of the invention devices and facilitates fast power supply voltage control of the distributed voltage regulation system by the load device.

### BRIEF DESCRIPTION OF THE FIGURES

FIG. 1 is an illustrative sub-set of components of one possible embodiment of the invention. It shows key circuit pathways that execute the advantageous functions of the invention.

FIG. 2 is an illustrative sub-set of components of an alternate embodiment of the invention. It similarly shows key circuit pathways of the invention.

FIG. 3 illustrates typical behavior of inductance value of an inductor employing magnetic core material with increasing magnetization, and permeability with flux density and temperature.

### DETAILED DESCRIPTION OF THE INVENTION

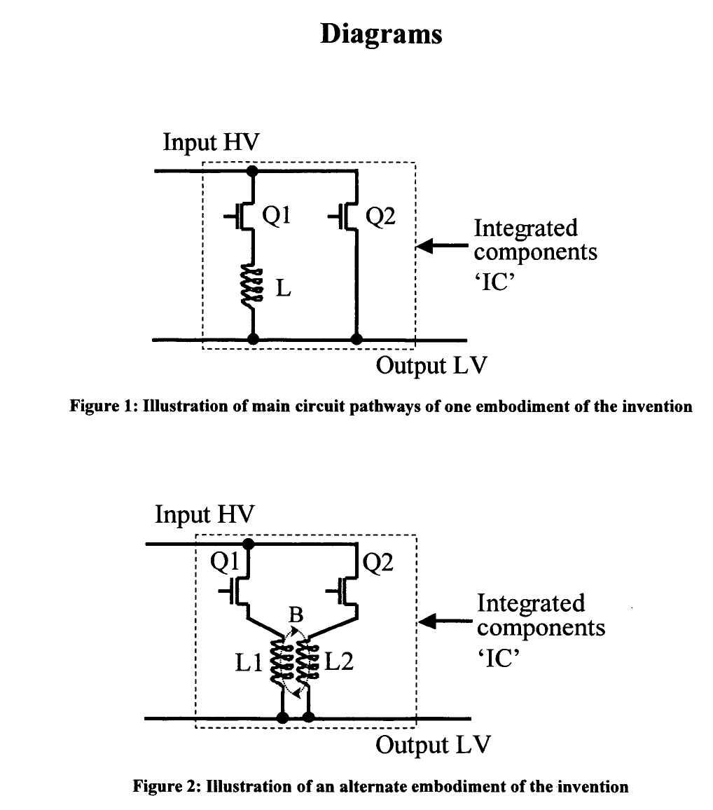

FIG. 1 illustrates a portion of one embodiment of the invention. A relatively higher voltage than that required by the load device is provided on the ‘Input HV’ power bus and the integrated DC-to-DC conversion system of the invention provides an output low voltage on the ‘Output LV’ power bus of the figure. Transistor ‘Q1’ and inductor ‘L’ form the high-side switch and inductor of a DC-to-DC converter. Device ‘Q2’, which may be a single transistor, or a combination of transistors functioning together as a normally ‘off’ switch or a switch at the threshold of ‘turn-on’ provides the ‘Bypass’ function of the invention. The three devices Q1, L and Q2 as well as other needed devices are integrated into a single integrated circuit (referred to as an IC Chip) and are also associated with external support capacitors that function as input and output filters. The external capacitors are connected between the HV and LV power buses and the system ‘ground’. One or more of the IC Chip embodiments of the invention and the filter capacitors are mounted in close proximity to each other and on the opposite side of the substrate that the load device (typically, a microprocessor) is mounted upon. In this manner, the physical distance and electrical delay in the interconnection between the distributed regulation system formed by the array of IC Chip embodiments and filter capacitors and the microprocessor load device are greatly minimized.

Under normal conditions, the DC-to-DC converter converts the input HV into an output LV voltage that provides load current to the load device. The bypass path consisting, in the example illustrated in FIG. 1, of NFET switch device Q2, is maintained at the threshold of turn-on by supplying a bias voltage to it's gate that is the sum of the desired output reference voltage ‘LV’ and the effective threshold voltage of the NFET switch device Q2. The retention of such a bias voltage at the gate of NFET switch Q2 (instead of the ‘ground’ voltage level that may presumably be easier to implement) has two significant benefits, in that it reduces the time required for Q2 to turn on in a load event demanding large charge inflows, and in that it helps minimize noise on the LV power line due to the self-regulating action of the Q2 NFET device.

When the load device initiates an event that will require a sudden, large inflow of charge, it communicates this information via a single, direct connection to each of the invention IC devices that are mounted in close proximity on the opposite side of the mounting substrate of the load device. This signal triggers circuits within the invention IC that pull the gate voltage of device Q2 up to the input high voltage ‘HV’ or above HV as may be desired through simple circuit elements such as PFET transistors connecting between the gate node of Q2 and the HV power bus and if necessary, an internally generated higher voltage within the invention IC. This action turns device Q2 fully on resulting in a large current flow, as permitted by the parasitic devices on the HV filter capacitors, into the output LV power line. This current flows into the load augmenting the charge flowing from the filter capacitors on the LV power bus into the load.

The invention IC device monitors the value of the HV power line in order to ensure that it does not fall below a value that jeopardizes the effectivity of the integrated DC-to-DC converter in delivering the output LV voltage. Additionally, by monitoring the output LV voltage, it shuts the bypass pathway when the LV voltage approaches the reference value programmed into the invention IC devices or over-ridden locally by a reference signal provided by the load device.

It is important to recognize that a high rate of repetitive activation of the bypass path in the invention IC devices may result in depletion of charge available in the filter capacitors on the HV power bus line. A recommended best-mode implementation of the invention system is therefore one wherein the invention devices function as a local array of high-bandwidth distributed regulators augmenting an existing, low-bandwidth input voltage power bus. In other words, it is recommended that the Output LV line connection between the invention IC's and the load device be also connected to an external LV power supply coming into the system formed by the load device, the mounting substrate and the invention IC devices and associated filter capacitors. In such a configuration, overshoots of the LV voltage are possible when the charge demand from the load is suddenly reduced. In that event, the invention IC may employ the integrated internal charge pumps to derive energy from the overshoots to feed into the HV filter capacitors. This may be accomplished simply by redirecting the output of the internal charge pumps to the input HV power bus as long as the overshoot exists on the output LV power bus.

Thermal design and packaging: One skilled in the art will appreciate that any voltage conversion system is associated with inherent inefficiency that leads to energy lost as heat. The invention IC devices, while providing higher efficiencies at high frequencies may therefore require heat extraction in order to maintain the junction temperatures at safe levels. This may be accomplished as an additional benefit of the close-proximity mounting of the invention IC devices and the load device. By minimizing the physical distance between the invention IC devices and the load device and maximizing the metallic (preferably, copper) interconnect between them, the thermal resistance between the two may be greatly minimized allowing for heat extraction through the prior art methods employed for cooling the load device. An example of such a system configuration could be an enhancement of the invention disclosed in reference 4, that claims the use of a flex tape as a flexible, high-density signal interconnect component. An enhanced invention embodiment could employ thin and thick flex tapes between the load device and the invention IC devices, with the thin flex tape providing pathways for signals and the thicker flex tape providing a measure of mechanical robustness, pathways for power interconnect and a relatively thinner common substrate with substantial copper metallization pathways for lower thermal resistance. The thicker flex tape of this embodiment will mount the invention IC devices as well as the input and output filter capacitors, and provide prior art interconnect techniques mating with an appropriate ‘socket’ component that mechanically holds this assembly.

Alternate embodiments: FIG. 2 illustrates a feasible alternate embodiment of the invention. In this embodiment, the bypass path is identical to the primary DC-to-DC converter path, and may assist the primary voltage conversion system in converting the input HV to the output LV voltage. The two current flow pathways are different in the current direction though the two inductors L1 and L2. L1 and L2 are related to each other very much as the primary and the secondary windings of a 1:1, ideal current or voltage transformer, with the current flow through the inductors producing opposing magnetic fields. The integrated DC-to-DC conversion system in the invention may employ only a single pathway for the voltage conversion, or may use both, as for example, in alternating phase durations due to the electromagnetic relationship between the two inductors. Additional devices, not shown in FIG. 2 and integrated into the invention IC device include the low-side switch devices of prior art ‘Buck’ DC-to-DC converters as well as control and regulation circuitry. External capacitors on the HV and LV power buses are also not shown.

Under normal operating conditions, in the absence of any sudden, large current demand (transient demand), this embodiment functions as a high-frequency, high-bandwidth DC-to-DC conversion system that augments the power bus line connecting to the load device. When a transient load requirement is detected through a signal from the load device, this embodiment transitions into a bypass operational mode. In this mode, both current flow pathways are activated simultaneously. Because the magnetic fields of the two inductors oppose and cancel each other, the inductors display highly reduced impedance to changing current flow and allow Q1 and Q2 to transfer charge from the input HV to the output LV power line at a rate limited primarily by the parasitic inductance of the input filter capacitors.

The effectivity of this embodiment depends upon maximizing the mutual inductance such that almost complete magnetic field cancellation is achieved in the simultaneous excitation of both inductors. The embodiment may provide full, continuous utilization of the transistor area in the invention IC, and may be a better option if the inductors can be fabricated satisfying the magnetic field cancellation requirement. While various techniques exist in the prior art for integrating low-resistance inductors onto monolithic integrated circuits, it is believed that open, vertical ring-like, or coil-like structures sharing magnetic core material and fabricated with a common core path upon the monolithic IC substrate would be best suited to the embodiment's bypass function.

Bypass function assisted by magnetic saturation: Alternately, an embodiment of the invention may be designed and fabricated such that the material that forms the magnetic core for the integrated inductors saturates beyond a maximum current through the inductors. Either of the two previously described invention embodiments may employ this enhancement, or the invention may simply contain the DC-to-DC conversion path that may beneficially also be used as the bypass path through magnetic saturation that minimizes the inductive impedance to changes in current.

In an embodiment employing magnetic saturation for the bypass function, the inductors and their core magnetic material may be designed and fabricated such that the inductors operate at the magnetic saturation limit during normal voltage conversion. The circuits and operating conditions may also be designed to ensure that sufficient timing margin is available, at the lower limit of the operating input HV voltage, to extend the duration that the switch device Q1 turns on in order to bring about magnetic saturation in the inductor core material.

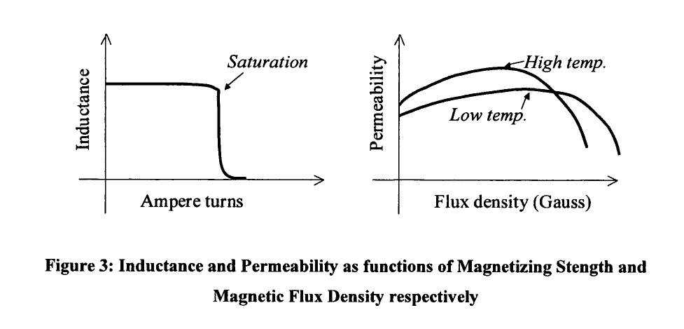

The invention embodiment functions as a high-bandwidth voltage conversion device under normal load conditions. The voltage conversion mode is suspended and the bypass mode is entered into when a transient requirement is indicated. In this mode, device Q1 (or Q1 and Q2) remain continuously on as long as the invention IC detects voltage sufficiency in the input HV power line and insufficiency in the output LV line. As the inductor current ramps up, it reaches the point of magnetic saturation, beyond which it's inductive impedance reduces significantly, (FIG. 3) allowing for a much greater rate of increase of current flow to the output LV line from the input HV filter capacitors, limited primarily by the input filter capacitor parasitic inductances.

This embodiment may eliminate an alternate bypass path altogether and incorporate the bypass function as an operational mode of the voltage conversion path itself. This is therefore most efficient in the utilization of the invention IC's integrated components, but is slower in transient suppression, and requires careful design of the magnetic behavior of the inductor core material as well as it's stability over the temperatures of operation of the invention device.

Although specific embodiments have been illustrated and described herein, any circuit arrangement configured to achieve the same purposes and advantages may be substituted in place of the specific embodiments disclosed. This disclosure by the inventor is intended to cover any and all adaptations or variations of the embodiments of the invention provided herein. All the descriptions provided in the specification have been made in an illustrative sense and should in no manner be interpreted in any restrictive sense. The scope, of various embodiments of the invention whether described or not, includes any other applications in which the structures, concepts and methods of the invention may be applied. The scope of the various embodiments of the invention should therefore be determined with reference to the appended claims, along with the full range of equivalents to which such claims are entitled. Similarly, the Abstract of this disclosure, provided in compliance with 37 CFR §1.72(b), is submitted with the understanding that it will not be interpreted to be limiting the scope or meaning of the claims made herein. While various concepts and methods of the invention are grouped together into a single ‘best-mode’ implementation in the detailed description, it should be appreciated that inventive subject matter lies in less than all features of any disclosed embodiment, and as the claims incorporated herein indicate, each claim is to viewed as standing on it's own as a preferred embodiment of the invention.

### REFERENCES

1. Massie, H. L.; U.S. Pat. No. 5,822,166, ‘DC power bus voltage transient suppressor circuit’, filed: Dec. 5, 1996
2. Nair, R.; U.S. Pat. No. 6,084,385, ‘System and method for multi-mode low power voltage regulator’, filed: Jun. 22, 1999
3. Nair, R.; U.S. Pat. No. 6,081,105, ‘Multi-mode low power voltage regulator’, filed: Mar. 8, 1999
4. Massie, H. L.; U.S. Pat. No. 6,285,175, ‘DC-to-DC converter with transient suppression’, filed: May 2, 2000
5. Thomas, T. P. et. al; U.S. Pat. No. 6,538,497, ‘On-chip power supply boost for voltage droop reduction’, filed: Mar. 27, 2001
6. Barnes, J. A. et. al; U.S. Pat. No. 6,677,736, ‘Energy recovery system for droop compensation circuitry’, filed: Sep. 28, 2001
7. R. Mahajan, Raj Nair et. al., ‘Emerging Directions in Packaging Technology’, Intel Technology Journal, Volume 6, Issue 2, May 2002 http://www.intel.com/technology/itj/2002/volume06issue02/art07_emergingdirections/p01_abstract.htm
8. Nair, R. and Tang, J.; ‘Decoupled Signal-Power Substrate Architecture’, U.S. Pat. No.______ pending, U.S. patent application Ser. No. 10/335,026
9. Ostrom, K. A.; U.S. Pat. No. 6,661,212, ‘Wideband regulator with fast transient suppression circuitry’, filed: Jan. 8, 2003
10. Orenchak, George; ‘Ferrites—“The most important properties”’, 1994 Soft Ferrites Users'Conference

1. An integrated voltage converter electronic circuit, comprising:
A plurality of integrated semiconductor and other electronic devices;
A first switch device connecting to an input power node at one of it's channel terminals and to a first integrated inductor at the other, with the first inductor's second terminal connecting to an output node, where this series combination of the first switch and the first inductor is a portion of an integrated voltage down-converter;
A bypass circuit path, formed by a second switch device, or a series combination of a second switch device equivalent to the first switch device and a second inductor of the same self-inductance value as the first inductor, where the bypass circuit path connects between the input power node and the output power node of the integrated circuit in an electrically parallel configuration with the series combination of the first switch and the first inductor;
Voltage conversion circuits and conversion-bypass control circuits, receiving a plurality of signals as input, and connecting to the power input and output nodes of the integrated circuit as well as the control inputs of the first and second switch devices;
And a common semiconductor substrate upon which the first switch device, the second switch device, necessary voltage conversion and control circuits, the first inductor, and the second inductor are fabricated.

2. The apparatus of claim 1 where the switch devices are transistors fabricated in the semi-conductor process employed to fabricate the common semiconductor substrate.

3. The apparatus of claim 1 where the switch devices are NMOS-FET (NFET) transistors, and further, where the turn-on control voltages provided to their control gate nodes may be higher than the input power node voltage and the turn-off control voltages may be higher than the output node voltage.

4. The apparatus of claim 1 where the inductors are fabricated using interconnect elements of high electrical conductivity embedded within a material of high magnetic permeability and high electrical resistivity upon the common semiconductor substrate.

5. The apparatus of claim 1 where the inductors share the same core magnetic flux path, thereby maximizing their consequent mutual inductance.

6. The apparatus of claim 1 where the electric current flow in the bypass pathway through the second inductor is such that the magnetic field therein created opposes and cancels the magnetic field created by the current flowing through the first inductor.

7. The apparatus of claim 1 where the first switch, the first inductor, the second switch and the second inductor are all employed for voltage conversion.

8. The apparatus of claim 1 where the magnetic material embedding the inductors is such that the inductors saturate when the current flowing through any inductor exceeds the peak current value that flows during normal voltage conversion.

9. The apparatus of claim 1 where the integrated voltage conversion and bypass control circuits received a bypass initiation analog or digital signal from the load device.

10. The apparatus of claim 1 where the integrated voltage conversion circuits receive an analog or digital signal from the load device for output voltage level programming.

11. The apparatus of claim 1 where electrical interconnection is accomplished between and by the invention device and the load device through electrical solder bumps on both semiconductor devices and interlayer package substrate interconnect through a common package substrate.

12. The apparatus of claim 1 where any signal communication is accomplished between and by the invention device and the load device through wireless RF, optical, or any non-contact signal communication methods through a common package substrate.

13. The apparatus of claim 1 where electrical interconnection between the invention device and the load device is accomplished through the thickness dimension of a common, thin, package substrate and through bulk or other material construction of very high thermal and electrical conductivity such as copper, carbon nanotubes, or alloys and composites that display similar or better thermal and electrical conductivity.

14. A 2-dimensional array of the invention devices of claim 1 integrated monolithically on the same semiconductor substrate, with necessary capacitance for the filter functions also integrated, employed as the mounting package substrate for the load device.

15. A method for transient suppression in high-bandwidth voltage regulation, comprising:
The integration of high-speed bypass pathways in parallel with voltage down-conversion pathways such as switching or linear regulators;
The activation of the bypass pathways in accordance with signals communicated by the load device requiring the transient charge flow;
And the connection of a plurality of such integrated devices, spatially distributed and in close physical proximity to the power grid of a load device, with input filter capacitors of sufficient value to supply the charge provided through the bypass pathways to the load without a detrimental degradation of the input voltage.

16. The method of claim 15 where a plurality of the integrated voltage conversion devices and associated output filter capacitors are placed directly opposite the regions of high transient current demand in the load power grid with a common package substrate between the load device and the distributed invention devices.

17. The method of claim 15 where the signal communicated by the load device indicating a transient load current demand comprises of an unusual, local, rate of change of, and absolute change of, the output node voltage.

18. The method of claim 15 where a transient, high current flow through the integrated voltage converter is facilitated by magnetic field cancellation or field saturation in the integrated inductors of the voltage converter.

19. Electronic systems comprised of various integrated and discrete electronic circuits and devices, electro-chemical, electro-thermal, electromechanical and electro-optic devices that employ the apparatus of claim 1 in any embodiment.

20. Electronic systems comprised of various integrated and discrete electronic circuits and devices, electrochemical, electro-thermal, electromechanical and electro-optic devices that employ the method of claim 15 in any embodiment.
